(19) United States
(12) Patent Application Publication
(10) Pub. No.: US 2022/0147280 A1
(43) Pub. Date: May 12, 2022

(54) EFFICIENT BUFFERING TECHNIQUE FOR TRANSFERRING DATA

(71) Applicant: Lightmatter, Inc., Boston, MA (US)

(72) Inventors: Darius Bunandar, Boston, MA (US); Cansu Demirkiran, Brookline, MA (US); Gongyu Wang, Newton, MA (US); Nicholas Moore, Boston, MA (US); Ayon Basumallik, Framingham, MA (US)

(73) Assignee: Lightmatter, Inc., Boston, MA (US)

(21) Appl. No.: 17/522,831

(22) Filed: Nov. 9, 2021

Related U.S. Application Data
(60) Provisional application No. 63/111,482, filed on Nov. 9, 2020.

(51) Int. Cl. G06F 3/06

(52) U.S. Cl. CPC G06F 3/0659; G06F 3/0656; G06F 3/0673; G06F 3/0613; G06F 3/0604

(57) ABSTRACT

Aspects of the present disclosure are directed to an efficient data transfer strategy in which data transfer is scheduled based on a prediction of the internal memory utilization due to computational workload throughout its runtime. According to one aspect, the DMA transfer may be performed opportunistically: whenever internal buffer memory is available and the additional internal memory usage due to DMA transfer isn't interfering with the processor's ability to complete the workload. In some embodiments, an opportunistic transfer schedule may be found by solving an optimization problem.

### CROSS-REFERENCE TO RELATED APPLICATIONS

This application claims the benefit of U.S. Provisional Application Ser. No. 63/111,482, filed on Nov. 9, 2020, under Attorney Docket No. L0858.70035US00 and entitled “AN EFFICIENT BUFFERING TECHNIQUE FOR TRANSFERRING DATA,” which is hereby incorporated herein by reference in its entirety.

### FIELD OF THE DISCLOSURE

This application is generally related to scheduling of data transfer between an external memory and an internal memory such as a buffer for a processor.

### BACKGROUND

In a computing system, the overall latency for a processor to complete processing a block of data is determined by the longer of two runtimes: a computational runtime for the processor to complete computation and a data transfer runtime to allow data transfer to/from an external memory unit from/to the processor.

Recent developments in computer processors have provided fast computational runtime for processing data, which puts the focus on improving overall latency on data transfer. Sometimes, the efficiency of fast computer processors can be restricted by the bandwidth for data transfer time into and out of these processors. For example, some processors have internal memory units that serve as buffers to temporarily store instructions and/or input data for the processors to operate on. If a bandwidth for data transfer between an external memory unit to the internal memory units is low, it can limit the throughput of the processors. As the amount of data available for the processors to process can be limited.

One example of recent advances in fast computer processors relates to deep learning computer chips, which have accelerated the computational runtime by architecting a computer system whose computational units are optimized for the operations within a neural network. For example, the tensor processors within a graphical processing unit (GPU) or the systolic multiply-and-accumulate (MAC) array within a tensor processing unit (TPU) are designed to complete matrix-matrix multiplications with as few clock cycles as possible.

Direct memory access or DMA is an operation to transfer data between an external memory and an internal memory. DMA uses a memory controller to schedule transfer of batches of data. DMA can free up involvement of the processor with the data transfer, such that the processor can focus on computation of the transferred data, thus improving overall latency.

When a large amount of data are involved, the processor may waste time waiting for DMA transfer to complete. Data transfer strategies such as double buffering (also called bounce buffering, and generally belongs to an overall class of multiple buffering) or circular buffering may be used to reduce the time for a processor to wait for DMA transfers. For example, double buffering divides the internal memory unit into two. While the computing cores perform computation with the data stored in the first half of the memory unit, data is being transferred into the second half from the external memory.

### SUMMARY OF THE DISCLOSURE

Some embodiments relate to a method of transferring data from a first memory to a second memory configured to store a batch of data to be processed by a processor. The method comprises determining a memory usage of the batch of data in the second memory to be processed by the processor; and based on the memory usage, scheduling data transfer from the first memory to the second memory.

In some embodiments, the memory usage comprises a first time series of memory usage over time by the processor of the batch of data in the second memory. The first memory may be external to the processor, the second memory may be a buffer memory for the processor, and the act of scheduling data transfer from the first memory to the second memory may comprise determining a direct memory access (DMA) transfer schedule.

In some embodiments, the DMA transfer schedule comprises a second time series of transfer bandwidth, and the act of determinizing the DMA transfer schedule comprises: optimizing the DMA transfer schedule until a function of the second time series of transfer bandwidth meets a predetermined criteria.

In some embodiments, the function may be computed using a convex optimization problem.

In some embodiments, the function is a size of a largest transfer bandwidth of the second time series of transfer bandwidth, and the act of optimizing comprises optimizing the DMA transfer schedule until the function is minimized.

In some embodiments, the method further comprises determining a third time series of memory usage over time in the second memory from data transferred from the first memory. The function may be a sum of the memory usage within the third time series over a period of time, and the act of optimizing comprises optimizing the DMA transfer schedule until the function is maximized.

In some embodiments, the method further comprises determining a third time series of memory usage over time in the second memory from data transferred from the first memory. For any given time: a sum of memory usage in the first time series with memory usage in the third time series is at least zero and no more than a maximum available memory amount in the second memory.

In some embodiments, the processor is configured to complete processing of the batch of data stored in the second memory within a runtime and at the end of the runtime. The memory usage in the second time series may equal a number of bits of a next batch of data.

In some embodiments, the processor is configured to complete processing of the batch of data stored in the second memory within a runtime. The sum of the memory usage in the third time series may be over a period of time that is longer than the runtime.

In some embodiments, the method further comprises: for each of a plurality of batch sizes of the batch of data in the second memory that are configured to be processed by the processor: optimizing the DMA transfer schedule; determining a throughput based on a ratio of the batch size and a runtime associated with the DMA transfer schedule; and selecting an optimal batch size having the highest throughput.

In some embodiments, the batch of data comprises a plurality of images in an image database.

Some embodiments relate to a system. The system comprises a first memory and a second memory; a processor configured to process a batch of data stored in the second memory; a memory controller configured to determine a direct memory access (DMA) transfer schedule for data transfer from the first memory to the second memory by: determining a memory usage of the batch of data in the second memory to be processed by the processor; and based on the memory usage, scheduling data transfer from the first memory to the second memory.

In some embodiments, the memory usage comprises a first time series of memory usage over time by the processor of the batch of data in the second memory, the DMA transfer schedule comprises a second time series of transfer bandwidth, and the memory controller is further configured to determine the DMA transfer schedule by: optimizing the DMA transfer schedule until a function of the second time series of transfer bandwidth meets a predetermined criteria.

In some embodiments, the function is a size of a largest transfer bandwidth of the second time series of transfer bandwidth, and the act of optimizing comprises optimizing the DMA transfer schedule until the function is minimized. The memory controller may be further configured to: determine a third time series of memory usage over time in the second memory from data transferred from the first memory. The function may be a sum of the memory usage within the third time series over a period of time, and the act of optimizing comprises optimizing the DMA transfer schedule until the function is maximized.

In some embodiments, the memory controller is further configured to: determine a third time series of memory usage over time in the second memory from data transferred from the first memory. For any given time: a sum of memory usage in the first time series and memory usage in the third time series is at least zero and no more than a maximum available memory amount in the second memory.

In some embodiments, the processor is configured to complete processing of the batch of data stored in the second memory within a runtime and at the end of the runtime, the memory usage in the second time series equals a number of bits of a next batch of data.

In some embodiments, the processor is configured to complete processing of the batch of data stored in the second memory within a runtime. The sum of the memory usage in the third time series may be over a period of time longer than the runtime.

In some embodiments, the memory controller is further configured to: for each of a plurality of batch sizes of the batch of data in the second memory that are configured to be processed by the processor: optimize the DMA transfer schedule; determine a throughput based on a ratio of the batch size and a runtime associated with the DMA transfer schedule; and select an optimal batch size having the highest throughput.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same reference number in all the figures in which they appear. In the drawings:

FIG. 1 shows an illustrative computing system 100 in which data transfer may take place, in accordance with some embodiments;

FIG. 2 shows an illustrative time series chart of memory usage for computation and memory usage for DMA transfer in an exemplary double-buffering DMA transfer;

FIG. 3 shows an illustrative process 300 for transferring data from one memory to another memory in a computing system, in accordance with some embodiments;

FIG. 4 shows an illustrative time series chart of memory usage for computation and memory usage for DMA transfer in an exemplary DMA transfer scheduled by solving a linear problem, in accordance with some embodiments;

FIG. 5A shows an illustrative time series chart of memory usage for computation and memory usage for DMA transfer in an exemplary double-buffering DMA transfer;

FIG. 5B shows an illustrative time series chart of memory usage for computation and memory usage for DMA transfer in an exemplary optimized data transfer strategy after solving linear program LP1, in accordance with some embodiments.

### DETAILED DESCRIPTION

Disclosed herein is an optimized data transfer method that schedules DMA transfer opportunistically based on memory usage over time, with the effect of a larger amount of data can be stored for transfer to the internal memory unit, which in effect can increase the computational throughput.

The inventors have recognized and appreciated that double-buffering schemes make a suboptimal use of the available internal memory capacity. Double buffering requires each half of the memory unit to allocate enough memory for the expected peak memory usage. For periods of the runtime where the memory usage doesn't hit its peak, double-buffering will lead to underutilization of the memory unit. Thus the internal memory utilization can be low if the amount of memory used throughout the computational runtime isn't uniform and constant or approximately uniform and constant over time.

The inventors have recognized and appreciated that the internal memory utilization and computational performance can be improved if peak memory usage is able to use substantially all of the internal memory available, as opposed to one-half as provided by the double-buffering schemes. Ideally, a data transfer scheme should provide that the total memory usage for computation may use up to all of the internal memory available less the amount of memory needed for transferring the data for future computation through DMA. For example, in the case of batched computation, computation is done on a current batch of input data and the next batch of input data must be transferred during the computation in order to not throttle the computation.

Aspects of the present application are directed to an efficient data transfer strategy in which data transfer is scheduled based on a prediction of the internal memory utilization due to computational workload throughout its runtime. According to one aspect, the DMA transfer may be performed opportunistically: whenever internal buffer memory is available and the additional internal memory usage due to DMA transfer isn't interfering with the processor's ability to complete the workload. In some embodiments, an opportunistic transfer schedule may be found by solving an optimization problem.

According to some aspects of the present application, an internal memory stores a current batch of data for computation by a processor, while data from an external memory is transferred to the internal memory as the next batch of data to be processed by the processor upon completion of processing of the current batch of data. In some embodiments, the memory usage in the internal memory by the processor is first determined, and the data transfer of the next batch of data is scheduled based on the memory usage. In some embodiments, the memory usage includes information such as the amount of internal memory usage for computation over time, which can have a peak usage of up to the maximum available capacity of the internal memory, as opposed to limited to one-half in double-buffering schemes.

In some embodiments, an optimization problem is solved to optimize a DMA transfer schedule for transfer of the next batch of data in incremental batches during the runtime of the current batch of data being processed by the processor. In some embodiments, the optimization problem involves solving of a linear program. In one embodiment, the optimization problem seeks to minimize a DMA transfer bandwidth. In another embodiment, the optimization problem seeks to maximize an area of a DMA data transfer curve versus time. According to an aspect, an effect of the optimized DMA transfer schedule is that a larger maximum batch size can be stored within the internal memory unit for computation, which may lead to higher compute utilization.

In some embodiments, a solution for an optimized DMA transfer schedule may not be found unless the time for DMA transfer is extended to a data transfer runtime that is longer the computational runtime tₘₐₓ needed for the processor to complete the current batch of data. This could arise due to a slow DMA bandwidth creating a bottleneck for the computing system such that transfer for the next batch of data cannot be completed by the runtime when computation for the current batch finishes. In some embodiments, a method is provided to optimize a batch size to maximize throughput, represented by a ratio between the batch size and the runtime.

Aspects of the present application may be applied in deep neural network operations that involve processing of a large amount of data, such as the evaluation of image or video (e.g., ImageNet) data in a computer vision network or the evaluation of language (e.g., SQuAD or MNLI) data in a natural language processing network, although it should be appreciated that embodiments described herein may be applied without limitation to computing systems that perform any type of data processing.

The aspects and embodiments described above, as well as additional aspects and embodiments, are described further below. These aspects and/or embodiments may be used individually, all together, or in any combination of two or more, as the application is not limited in this respect.

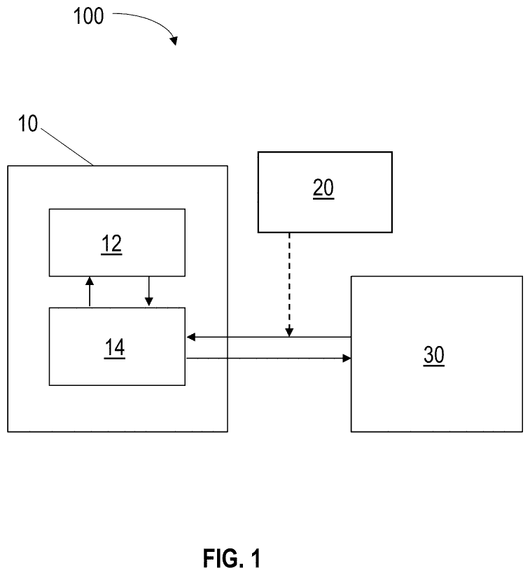

FIG. 1 shows an illustrative computing system 100 in which data transfer may take place, in accordance with some embodiments. Computing system 100 includes a processor 10, a memory 30, and a controller 20. Memory 30 may be a first memory unit that is an external to the processor 10. Controller 20 may be a memory controller that causes data to be transferred between the external memory unit 30 and a second memory 14. Second memory 14 may be an internal memory unit disposed within processor 10. Processor 10 also comprises one or more computing cores 12 that are configured to perform computation using the data available within the internal memory unit 14.

In computing system 100, the external memory unit 30 may include one or more volatile memory units, one or more non-volatile memory units, or combinations thereof. In some embodiments, the external memory unit 30 may be a dynamic random-access memory (DRAM) such as but not limited to a double data rate (DDR), hybrid memory cube, or a high-bandwidth memory (HBM). External memory unit 30 may have a capacity of more than 16 GB, more than 32 GB, more than 64 GB, or more than 128 GB. In another embodiment, the external memory unit 30 may comprise a static random-access memory (SRAM) array of a host CPU.

Internal memory unit 14 may consist of an SRAM array, and may have a smaller capacity than the external memory unit, such as but not limited to a capacity of between 1 and 100 MB, between 1 and 1000 MB, or between 10 and 1000 MB.

In computing system 100, processor 10 may include one or more processing units such as one or more of a GPU, a TPU, or any other processing unit types known to a person skilled in the field. Computing system 100 may be any general-purpose computer, or in some embodiments may be a high-performance computing system such as a machine learning accelerator. As shown in FIG. 1, processor 10 includes one or more computing cores 12 in communication with internal memory unit 14 using any suitable interface known in the field. Internal memory unit 14 may comprise a single memory chip, or an array of memory chips. Internal memory unit 14 and computing cores 12 may be disposed within a same package for processor 10, although it is not a requirement. It should be appreciated that aspects of the present application may be applied to any physical implementation of computing cores 12, internal memory unit 14, and external memory unit 30.

In a non-limiting example, processor 10 may be part of a high throughput hybrid analog-digital computing system that includes photonic hybrid processors. Some aspects of a hybrid analog-digital computing system are described in U.S. patent application Ser. No. 17/246,892, Attorney Docket Number L0858.70011US04, filed on May 3, 2021 and entitled “HYBRID ANALOG-DIGITAL MATRIX PROCESSORS,” the disclosure of which is hereby incorporated by reference in its entirety.

In some embodiments, data transfer between external memory unit 30 and internal memory unit 14 is provided by a DMA transfer, and controller 20 is a DMA controller. Controller 20 may include a storage unit that stores one or more instructions to program the DMA controller to perform any of the functions described herein relating to data transfer. The DMA controller may be part of a chipset, e.g., an x86 CPU or an FPGA, or it may be a separate chipset. It may also be on the same chipset as the external memory unit 30, or the controller 20 and external memory unit 30 may be on different chipsets.

In some embodiments, the access for data stored in external memory unit 30 from computing core 12 is limited by the data transfer bandwidths between the external and internal memory units. In some embodiments, the DMA between the external and internal memory units may be performed over a PCI-express fabric with bandwidths up to ˜126 GB/s or an HBM link with bandwidths up to ˜460 GB/s, although any suitable bus or interface may be used. On the other hand, the data transfer bandwidth is generally much faster between the computing cores and the internal memory unit may be much faster. In some embodiments, the data transfer bandwidth between the internal memory unit and the computing cores may be at least 100 Tbps, at least 200 Tbps, or at least 500 bps.

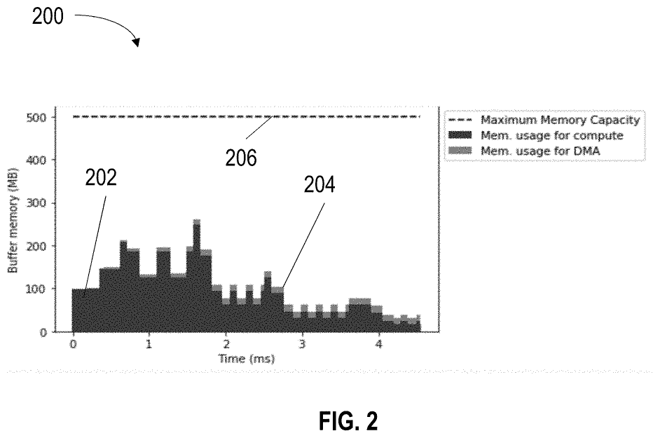

FIG. 2 shows an illustrative time series chart of memory usage for computation and memory usage for DMA transfer in an exemplary double-buffering DMA transfer. The chart 200 in FIG. 2 illustrates the overall memory usage of evaluating ImageNet data using the ResNet-50 deep neural network in a photonic processing core with double buffering DMA strategy. In this example, the internal memory unit has a maximum memory capacity of 500 MB labeled as 206. The bars 202 represent a time series of the memory required for storing the input and output activations. As shown in FIG. 2, bars 202 are a non-constant memory usage over time, with a peak usage by the processor at around 1.5 ms of the runtime. The bars 204 represent a time series of the memory DMA. The horizontal axis is a runtime for the computation and data transfer.

In the exemplary application in FIG. 2, generally the larger the number of different image data (or batch size) is, the higher is the utilization of the computing core. As shown in FIG. 2, when double-buffering is used, the maximum batch size that can be stored in the internal memory unit is limited by the peak memory usage that must fit below one-half of the overall internal memory space 206. The strategy limits the batch size to only 54 images, with a total of 4.55 ms evaluation time or computational runtime, and thus leads to underutilization of the internal memory unit, which may further lead to underutilization of the compute core. It should be further appreciated that while batch size is represented by a number of images, any suitable unit may be used to represent a measure of the batch size, as aspects of the present application are not limited to image processing applications. For example, memory usage and a size of a batch of data may be measured by a number of bits.

Some aspects of the present application are directed to a method to schedule DMA transfer. In some embodiments, an optimization problem may be solved to determine an optimized DMA transfer schedule for the next batch of data based on computational memory utilization for the current batch of data.

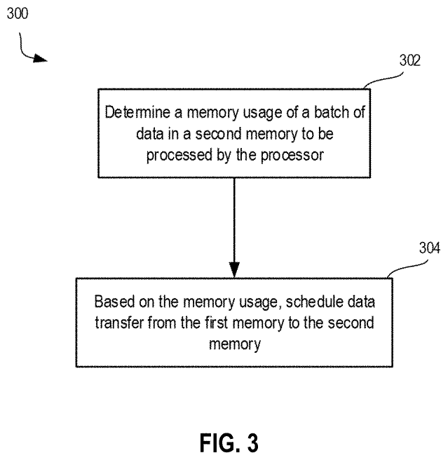

FIG. 3 shows an illustrative process 300 for transferring data from one memory to another memory in a computing system, in accordance with some embodiments. For instance, process 300 may be performed by a computing system such as computing system 200 shown in FIG. 2. In FIG. 3, process 300 includes act 302, during which the process determines a memory usage of a batch of data in a second memory that are to be processed by the processor. At act 304, the process schedules, based on the memory usage determined at act 302, data transfer from the first memory to the second memory.

Examples of process 300 using DMA transfer between an external memory and an internal memory are described in more detail below.

Let \vec{x_{c}} be the internal memory usage for computing the current batch of data, and let \vec{x}_{DMA} be the internal memory usage for copying the next batch of data. Both \vec{x_{c}} and \vec{x}_{DMA} are vectors representing a time series of the memory usage over time. For example,

\vec{x}_{c}=[x_{c}(t₀),x_{c}(t₁), . . . ,x_{c}(tₘₐₓ)]

and

\vec{x}_{DMA}=[x_{DMA}(t₀),x_{DMA}(t₁), . . . ,x_{DMA}(tₘₐₓ)],

where tᵢ₊₁=tᵢ+Δt, and Δt is a preprogrammed time interval or time step. In some embodiments, Δt may be an integer multiple of a clock cycle, an increment in wall-clock time, or any other suitable time interval. According to one aspect, Δt may be selected such that the computational time for solving the optimization program (such as the exemplary linear programs to be described below) is tractable by the computer solving such program.

Next, define Δx_{DMA}(tᵢ)=x_{DMA}(tⱼ)−x_{DMA}(tᵢ₋₁), which is the amount of data being transferred over DMA to the internal memory within a period of Δt. Δx_{DMA}(t) is, therefore, a measure of data transfer bandwidth from the external memory to the internal memory. By default, x_{DMA}(t₋₁)≡0, which is a reasonable assumption given that the data transfer for the next batch should not start before the computation of the current batch of data starts. Define another vector:

\vec{Δx}_{DMA}=[Δx_{DMA}(t₀),Δx_{DMA}(t₁), . . . ,Δx_{DMA}(tₘₐₓ)].

By such definitions, \vec{x_{c}} may be a first time series of memory usage for computation; \vec{Δx}_{DMA} may be a second time series of incremental data batches transferred from the external memory; while \vec{x}_{DMA} may be a third time series of memory usage for data copied into the internal memory as the next batch.

In some embodiments, the internal memory utilization due to the computation workload during the computational runtime may be determined by a prediction considering the temporal and spatial utilization of the current data being accessed by the computing processor or processor cores. In some cases, the entire computational graph—and hence the internal memory utilization—may be determined beforehand. For example, for deep neural networks, the neural network graph may be sufficient to determine the entire computational workload. This is typically the case for computations that do not involve control flows. However, even when the internal memory utilization cannot be computed analytically beforehand, it can be deduced empirically. For example, one can run several iterations of the computation with example data or synthetic data to find the typical internal memory utilization.

The inventors have recognized and appreciated that for a known memory utilization due to computation (\vec{x_{c}}) an optimal DMA transfer schedule can be found by solving an objective function of one or more of the time series as input until the objective function returns a predetermined criteria.

In one embodiment, the following linear program LP1 is a convex optimization problem that can serve as an objective function. The objective function's criteria is met when the maximum DMA transfer bandwidth:

Minimize max(Δx_{DMA}) (LP1)

Solving LP1 may be subject to the following five constraints:

0≤x_{c}(t)+x_{DMA}(t)≤xₘₐₓ, (Constraint 1.1)

x_{DMA}(t)≥0, (Constraint 1.2)

x_{DMA}(t₋₁)=0, (Constraint 1.3)

x_{DMA}(tₘₐₓ)=xᵢₙₚᵤₜ, (Constraint 1.4)

0≤Δx_{DMA}(t)≤maximum DMA bandwidth. (Constraint 1.5)

Constraint 1.1 means that the total memory usage for both computation and DMA transfer cannot exceed the maximum available memory xₘₐₓ.

Constraint 1.2 restricts the DMA memory usage to be positive.

Constraint 1.3 means that the DMA transfer for the next batch cannot happen before computation for the previous batch starts.

Constraint 1.4 means that all necessary input data xᵢₙₚᵤₜ to start the next batch of computation must be transferred before the computation finishes at time tₘₐₓ.

Constraint 1.5 restricts the DMA transfer bandwidth into the internal memory unit by the maximum bandwidth afforded, and ensures that the scheme only copies data into the processor (and not out of the processor, which is a waste of bandwidth).

It should be understood that when the value of time t is undefined in the constraints for solving problem LP1 above, it is intended that the constraint applies to all values of t.

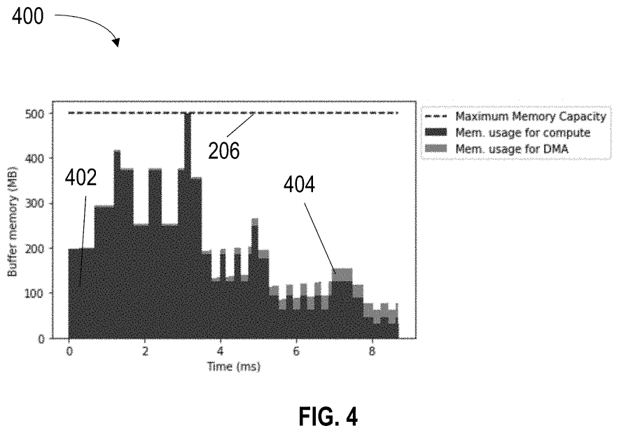

FIG. 4 shows an illustrative time series chart of memory usage for computation and memory usage for DMA transfer in an exemplary DMA transfer scheduled by solving a linear problem, in accordance with some embodiments. The chart 400 in FIG. 4 illustrates an overall memory usage of evaluating ImageNet data through the ResNet-50 deep neural network with a DMA strategy optimized using linear program LP1, based on the same hardware configuration as those used in chart 200 shown in FIG. 2. The bars 402 represent a time series of the memory required for storing the input and output activations. The bars 404 represent a time series of the memory DMA. The horizontal axis is a runtime for the computation and data transfer.

As shown in FIG. 4, when using the optimized DMA transfer schedule, the maximum batch size that can be evaluated by the processor is 108 images (with a total evaluation time of 8.57 ms) which is twice the batch size possible with double buffering as shown in FIG. 2. The comparison between FIGS. 2 and 4 illustrates that optimizing DMA transfer using the linear program LP1 increases the utilization of the internal memory unit. It should be appreciated that although the total evaluation time for the larger batch of images is longer, the total throughput of the processor 108/8.57 ms=12,602 images/s is higher than the throughput of the processor when utilizing double buffering: 54/4.55 ms=11,868 images/s. The increase in internal memory utilization increases the throughput of the processor towards the roofline performance for the specific workload.

To further illustrate the effect of the data transfer method described herein, both double-buffering and an exemplary optimized DMA transfer process are applied to a BERT-large neural network. A comparison of the results is described below.

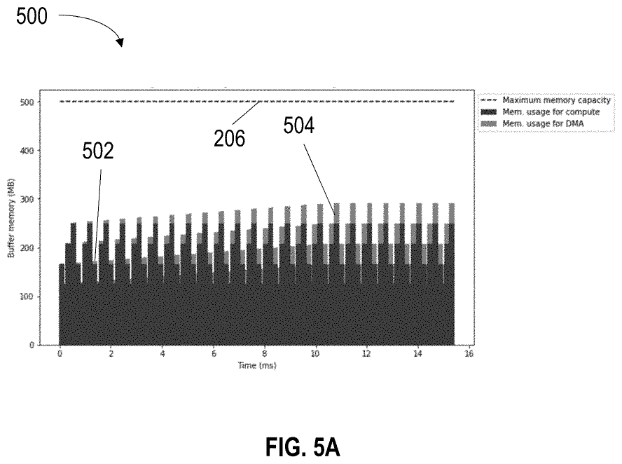

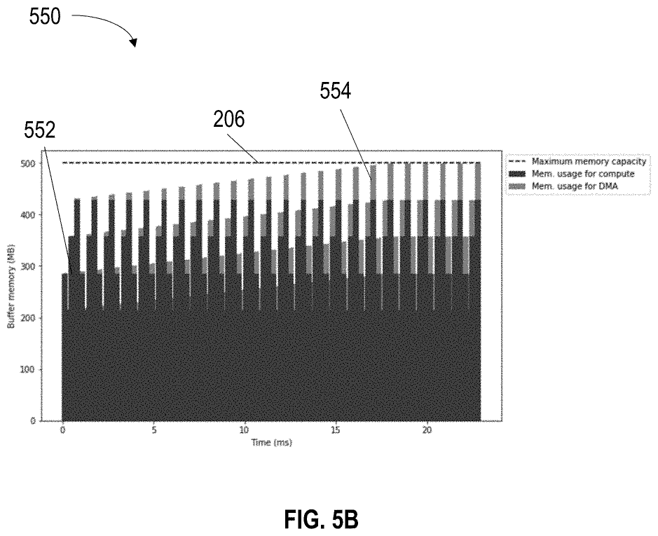

Bidirectional Encoder Representations from Transformers (BERT) is a natural language processing neural network capable of performing many different tasks including translation, question-answering, and sentiment analysis. FIG. 5A shows an illustrative time series chart of memory usage for computation and memory usage for DMA transfer in an exemplary double-buffering DMA transfer. The chart 500 in FIG. 5A illustrates the overall memory usage of evaluating BERT-large through the same photonic processing unit used for FIG. 4 with the double-buffering strategy. The bars 502 represent a time series of the memory required for computation. The bars 504 represent a time series of the memory usage for DMA transfer. As shown in FIG. 5A, the memory usage for computation in a BERT-large network is fairly uniform and repetitive, which is different from the memory usage for computation in ResNet-50 which has a peak in the middle of the evaluation as shown in FIG. 2.

FIG. 5B shows an illustrative time series chart of memory usage for computation and memory usage for DMA transfer in an exemplary optimized data transfer strategy after solving linear program LP1, in accordance with some embodiments. In the chart 550 shown in FIG. 5B, the bars 552 represent a time series of the memory required for computation. The bars 554 represent a time series of the memory usage for DMA transfer. The resulting DMA transfer schedule in FIG. 5B shows that because the memory usage for computation in a BERT-large network is fairly uniform and repetitive, the optimal memory usage while avoiding any data transfer bottleneck is to not to apportion the total internal memory to computation alone.

In the embodiment described above, solving the linear program LP1 will return a DMA transfer schedule if a solution is found. Linear programs are generally easy to solve for practical problem sizes, but if a solution is not found, it could be because the problem is too large to be tractable by the computer and the algorithm being used, or because the problem does not admit any solution. To handle the case where a solution may not be found, one or more variations of the linear program can be applied.

One variation to allow the program to always have a solution is to remove Constraint 1.5 and then check the optimized objective function. With this formulation, a solution is only not found when the problem is intractable by the hardware and algorithm. If max(Δx_{DMA}) is larger than the maximum DMA bandwidth of the hardware, then there is no DMA transfer schedule that can finish the data transfer for the next batch before the computation for the current batch finishes. In this case, DMA transfer will become a bottleneck: extending the computational time beyond tₘₐₓ.

As another variation, the linear program can also be tweaked to solve a different objective function such as the linear program below:

Maximize Σₜ₌₁^{t′}^{ₘₐₓ}x_{DMA}(t) (LP2)

Subject to:

0≤x_{c}(t)+x_{DMA}(t)≤xₘₐₓ, (Constraint 2.1)

x_{DMA}(t)≥0, (Constraint 2.2)

x_{DMA}(t₋₁)=0, (Constraint 2.3)

x_{DMA}(tₘₐₓ)=xᵢₙₚᵤₜ, (Constraint 2.4)

0≤Δx_{DMA}(t)≤max. DMA bandwidth, (Constraint 2.5)

while allowing time t to extend to t′ₘₐₓ≥tₘₐₓ. The objective function above seeks to maximize the area under the curve for the memory usage for the DMA data transfer. In other words, the linear program LP2 looks for a DMA transfer schedule that aims to complete the DMA data transfer as soon as possible. By allowing the time t to extend to t′ₘₐₓ≥tₘₐₓ, the program can find a solution that extends beyond the computational runtime of the first batch. According to an aspect, solving LP2 may provide a solution where DMA transfer is a bottleneck.

Another aspect of the present application provides a method to determine the optimal data batch size for a specific workload. Solving the linear programs involves a determination of the size of the data batch, for example by making assumptions of the batch size, or by prediction based on a neural network graph in certain applications. In practice, the batch size that the processor can handle with the highest throughput may not be easily calculated because, in general, the relationship between batch size and computational runtime is non-linear. The inventors have recognized and appreciated that a linear program can be used to search for an optimal batch size by selecting a batch size that maximizes throughput. An example of the batch size optimization method is described in the pseudocode below:

Set highest_throughput←0, optimal_batch_size←0

For batch_size in range(min_batch_size, max_batch_size):
Run LP2 for the batch size of batch size
If LP2 finds a solution:
   Calculate the maximum_runtime←max(computational runtime, data transfer runtime)
   Calculate throughput←batch_size/maximum_runtime
   If throughput>highest_throughput:
      highest_throughput←throughput
      optimal_batch_size←batch_size
Else:
   Pass

Output optimal_batch_size

The technique can also be applied in the case of a parallel computation, where the external memory unit corresponding is connected to N>1 processors. Each one of the processors may be performing the same computation or running a different program. The former means that the time series of internal memory utilization for each processor is the same, while the latter means that the time series of internal memory utilization for each processor can be different. The linear programs can be modified to take into account the DMA transfer from the external memory unit to the different processors. For example, LP2 can be generalized into LP3:

Maximize Σᵢ₌₁^{N}Σₜ₌₁^{t′}^{ₘₐₓ}x⁽ⁱ⁾_{DMA}(t) (LP3)

Subject to:

0≤x⁽ⁱ⁾_{c}(t)+x⁽ⁱ⁾_{DMA}(t)≤x⁽ⁱ⁾ₘₐₓ, (Constraint 3.1)

x⁽ⁱ⁾_{DMA}(t)≥0, (Constraint 3.2)

x⁽ⁱ⁾_{DMA}(t₋₁)=0, (Constraint 3.3)

x⁽ⁱ⁾_{DMA}(tₘₐₓ)=x⁽ⁱ⁾ᵢₙₚᵤₜ, (Constraint 3.4)

0≤Δx⁽ⁱ⁾_{DMA}(t)≤max. DMA bandwidth, (Constraint 3.5)

where the superscript (i) corresponds to which processor. LP3 considers the case where (1) there is no communication between the different N processors and where (2) there is a dedicated DMA channel from the external memory to each processor. Additional constraints can be added to consider the case where (1) communications are needed between the different N processors and (2) the DMA bandwidth from the external memory is shared among all the processors.

Having thus described several aspects of at least one embodiment of this invention, it is to be appreciated that various alterations, modifications, and improvements will readily occur to those skilled in the art. For example, while transfers of a batch of data between an external memory unit and an internal memory unit are disclosed as examples, it should be appreciated that aspects of the present application are not so limited in terms of the nature of the data transfer and the physical memory units. As an example, the data transfer methods disclosed herein may apply to data transfer from/to a single memory chip, or a plurality of memory chips. Furthermore, a data transfer may be carried out in more than one stages, and the data transfer methods disclosed herein may also apply to a multi-stage data transfer.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A method of transferring data from a first memory to a second memory configured to store a batch of data to be processed by a processor, the method comprising:
determining a memory usage of the batch of data in the second memory to be processed by the processor; and
based on the memory usage, scheduling data transfer from the first memory to the second memory.

2. The method of claim 1, wherein
the memory usage comprises a first time series of memory usage over time by the processor of the batch of data in the second memory.

3. The method of claim 2, wherein
the first memory is external to the processor, the second memory is a buffer memory for the processor, and
the act of scheduling data transfer from the first memory to the second memory comprises determining a direct memory access (DMA) transfer schedule.

4. The method of claim 3, wherein
the DMA transfer schedule comprises a second time series of transfer bandwidth, and
the act of determinizing the DMA transfer schedule comprises:
optimizing the DMA transfer schedule until a function of the second time series of transfer bandwidth meets a predetermined criteria.

5. The method of claim 4, wherein
the function is computed using a convex optimization problem.

6. The method of claim 4, wherein
the function is a size of a largest transfer bandwidth of the second time series of transfer bandwidth, and
the act of optimizing comprises optimizing the DMA transfer schedule until the function is minimized.

7. The method of claim 4, further comprising:
determining a third time series of memory usage over time in the second memory from data transferred from the first memory; and wherein
the function is a sum of the memory usage within the third time series over a period of time, and
the act of optimizing comprises optimizing the DMA transfer schedule until the function is maximized.

8. The method of claim 6, further comprising:
determining a third time series of memory usage over time in the second memory from data transferred from the first memory; and wherein for any given time:
a sum of memory usage in the first time series with memory usage in the third time series is at least zero and no more than a maximum available memory amount in the second memory.

9. The method of claim 8, wherein
the processor is configured to complete processing of the batch of data stored in the second memory within a runtime and
at the end of the runtime, the memory usage in the second time series equals a number of bits of a next batch of data.

10. The method of claim 7, wherein
the processor is configured to complete processing of the batch of data stored in the second memory within a runtime and wherein
the sum of the memory usage in the third time series is over a period of time longer than the runtime.

11. The method of claim 4, further comprising:
for each of a plurality of batch sizes of the batch of data in the second memory that are configured to be processed by the processor:
optimizing the DMA transfer schedule;
determining a throughput based on a ratio of the batch size and a runtime associated with the DMA transfer schedule; and
selecting an optimal batch size having the highest throughput.

12. The method of claim 1, wherein
the batch of data comprises a plurality of images in an image database.

13. A system comprising:
a first memory and a second memory;
a processor configured to process a batch of data stored in the second memory;
a memory controller configured to determine a direct memory access (DMA) transfer schedule for data transfer from the first memory to the second memory by:
determining a memory usage of the batch of data in the second memory to be processed by the processor; and
based on the memory usage, scheduling data transfer from the first memory to the second memory.

14. The system of claim 13, wherein
the memory usage comprises a first time series of memory usage over time by the processor of the batch of data in the second memory,
the DMA transfer schedule comprises a second time series of transfer bandwidth, and
the memory controller is further configured to determine the DMA transfer schedule by:
optimizing the DMA transfer schedule until a function of the second time series of transfer bandwidth meets a predetermined criteria.

15. The system of claim 14, wherein
the function is a size of a largest transfer bandwidth of the second time series of transfer bandwidth, and
the act of optimizing comprises optimizing the DMA transfer schedule until the function is minimized.

16. The system of claim 14, wherein the memory controller is further configured to:
determine a third time series of memory usage over time in the second memory from data transferred from the first memory; and wherein
the function is a sum of the memory usage within the third time series over a period of time, and
the act of optimizing comprises optimizing the DMA transfer schedule until the function is maximized.

17. The system of claim 15, wherein the memory controller is further configured to:
determine a third time series of memory usage over time in the second memory from data transferred from the first memory; and wherein for any given time:
a sum of memory usage in the first time series and memory usage in the third time series is at least zero and no more than a maximum available memory amount in the second memory.

18. The system of claim 17, wherein
the processor is configured to complete processing of the batch of data stored in the second memory within a runtime and
at the end of the runtime, the memory usage in the second time series equals a number of bits of a next batch of data.

19. The system of claim 16, wherein
the processor is configured to complete processing of the batch of data stored in the second memory within a runtime and wherein
the sum of the memory usage in the third time series is over a period of time longer than the runtime.

20. The system of claim 14, wherein the memory controller is further configured to:
for each of a plurality of batch sizes of the batch of data in the second memory that are configured to be processed by the processor:
optimize the DMA transfer schedule;
determine a throughput based on a ratio of the batch size and a runtime associated with the DMA transfer schedule; and
select an optimal batch size having the highest throughput.
